(19) United States
(12) Patent Application Publication
(10) Pub. No.: US 2012/0307893 A1
(43) Pub. Date: Dec. 6, 2012

(54) FAST COMPUTING OF DISCRETE COSINE AND SINE TRANSFORMS OF TYPES VI AND VII

(75) Inventors: Yuriy Reznik, San Diego, CA (US); Ravi Kiran Chivukula, San Diego, CA (US)

(73) Assignee: QUALCOMM INCORPORATED, San Diego, CA (US)

(21) Appl. No.: 13/484,032

(22) Filed: May 30, 2012

Related U.S. Application Data
(60) Provisional application No. 61/492,759, filed on Jun. 2, 2011.
(60) Provisional application No. 61/525,673, filed on Aug. 19, 2011.
(60) Provisional application No. 61/533,662, filed on Sep. 12, 2011.

(51) Int. Cl. H04N 7/30; H04N 7/32

(52) U.S. Cl. 375/240.12; 375/240.2; 375/E07.226; 375/E07.243; 375/E07.027

(57) ABSTRACT

This disclosure presents techniques for implementing a fast algorithm for implementing odd-type DCTs and DSTs. The techniques include the computation of an odd-type transform on any real-valued sequence of data (e.g., residual values in a video coding process or a block of pixel values of an image coding process) by mapping the odd-type transform to a discrete Fourier transform (DFT). The techniques include a mapping between the real-valued data sequence to an intermediate sequence to be used as an input to a DFT. Using this intermediate sequence, an odd-type transform may be achieved by calculating a DFT of odd size. Fast algorithms for a DFT may be then be used, and as such, the odd-type transform may be calculated in a fast manner

This application claims the benefit of U.S. Provisional Application No. 61/492,759, filed on Jun. 2, 2011, U.S. Provisional Application No. 61/525,673, filed on Aug. 19, 2011, and U.S. Provisional Application No. 61/533,662, filed on Sep. 12, 2011, the contents of which are hereby incorporated by reference in their entirety.

### TECHNICAL FIELD

This disclosure relates to image and video compression, and more specifically to transforms used in performing image and video compression.

### BACKGROUND

In general, discrete sine transforms (DSTs) and discrete cosine transforms (DCTs) are used in source coding for image, speech, audio and video data. The type II DCT typically is at the core of standards for image and video compression, such as Joint Photographic Experts Group (JPEG), H.26x-series video coding, and the Motion Pictures Experts Group (MPEG) 1-4 standards. The type-1 DST was suggested as a basis for a recursive block coding technique for video coding. The type IV DCT and type IV DST are both found in fast implementations of Lapped Orthogonal Transforms, which are used in speech and audio coding standards, such as G.722.1, G.718, and the MPEG AAC-family.

Through the extensive use of DCTs and DSTs of types I, II, III, and IV (which are often referred to as “even” transforms) in coding image, video, speech and audio data, many different factorizations and fast algorithms for implementing these transforms have been developed it improve precision and promote reduced computational complexity. The so-called “odd-type” DCTs and DSTs of types V, VI, VII, and VIII, however, have not been widely used for purposes of coding image, video, speech and audio data. For this reason, implementations of these transforms have been underdeveloped, resulting in implementations of the odd transforms that tend to be slow and computationally complex.

### SUMMARY

In general, this disclosure presents techniques for implementing a fast algorithm for implementing odd-type DCTs and DSTs. The techniques include the computation of an odd-type transform on any real-valued sequence of data (e.g., residual values in a video coding process or a block of pixel values of an image coding process) by mapping the odd-type transform to a discrete Fourier transform (DFT). The techniques include a mapping between the real-valued data sequence to an intermediate sequence to be used as an input to a DFT. Using this intermediate sequence, an odd-type transform may be achieved by calculating a DFT of odd size. Fast algorithms for a DFT may be then be used, and as a result, the odd-type transform may be calculated in a manner that requires less computational complexity, potentially improving the speed with which such odd-type transforms may be performed.

In one embodiment, the invention is directed to a method for computing an odd-type discrete sine transform (DST) or discrete cosine transform (DCT) in a video or image coding process. The method includes receiving a sequence of real-valued data on which to perform an odd-type transform, mapping the sequence of real-valued data to an intermediate sequence, and applying the intermediate sequence as an input to a discrete Fourier transform (DFT) to produce transformed data according to the odd-type transform. The odd-type transform comprises one of a DST of type V, a DCT of type V, a DST of type VI, a DCT of type VI, a DST of type VII, a DCT of type VII, a DST of type VIII, and a DCT of type VIII.

In another embodiment, the invention is directed to an apparatus configured to compute an odd-type discrete sine transform (DST) or discrete cosine transform (DCT) in a video or image coding process. The apparatus includes a coding module configured to receive a sequence of real-valued data on which to perform an odd-type transform, a mapping unit configured to map the sequence of real-valued data to an intermediate sequence, and a transform module configured to apply the intermediate sequence as an input to a discrete Fourier transform (DFT) to produce transformed data according to the odd-type transform.

In another embodiment, the invention is directed to a computer program product comprising a computer-readable storage medium having, stored thereon instructions for a processor of a device configured to compute an odd-type discrete sine transform (DST) or discrete cosine transform (DCT) in a video or image coding process. The instructions cause the processor to receive a sequence of real-valued data on which to perform an odd-type transform, map the sequence of real-valued data to an intermediate sequence, and apply the intermediate sequence as an input to a discrete Fourier transform (DFT) to produce transformed data according to the odd-type transform.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a conceptual diagram illustrating an example mapping between a DST of Type VI and a discrete Fourier transform.

FIG. 1B is a conceptual diagram illustrating an example mapping between a DCT of Type VI and a discrete Fourier transform.

FIG. 2A is a block diagram illustrating a generalized example of an image or video encoder.

FIG. 2B is a block diagram illustrating a generalized example of an image or video decoder.

FIG. 3 is a block diagram illustrating an example odd-type transform module.

FIG. 4 is a block diagram illustrating an example video encoding and decoding system.

FIG. 5 is a block diagram illustrating an example video encoder.

FIG. 6 is a block diagram illustrating an example video decoder.

FIG. 7 is a flowchart illustrating an example process for performing an odd-type transform.

FIG. 8A is a flowchart illustrating an example process for performing an odd-type transform in a video coding process.

FIG. 8B is a flow chart illustrating an example process for performing an odd-type transform in a video decoding process.

### DETAILED DESCRIPTION

In general, this disclosure presents techniques for implementing a fast algorithm for calculating “odd” type transforms, and in particular, DCTs or DSTs of types VI and VII. A transform is a mathematical algorithm that transforms an original function (often a function in the time domain) into a transformed function in the frequency domain. Transforms have many uses in computing, including solving partial differential equations, performing convolutions, multiplying large integers, lossy compression of audio (e.g., in MP3 encoding), image compression (e.g., in JPEG encoding), and video compressions (e.g., in the H.264 or high efficiency video coding (HEVC) standards).

Odd-type transforms (i.e., DCTs and DSTs of types V, VII, VII, and VIII) have not traditionally been widely used in video and image compression techniques. For one reason, fast algorithms for implementing the odd-type transforms have not been developed. However, the DST of type VI has shown recent promise for use in image/video coding. In particular, the DST of type VI can be obtained as an approximation of the Karhunen-Loeve transform (KLT) for residual signals, such as ones produced after a prediction process in video coding (e.g., intra-prediction or inter-prediction). In particular, the DST of type VI has been shown to offer better performance in situations where the variances of residual values from intra-prediction increase in conjunction with distance from the edge of a block. Further, these transforms were recently adopted in the high efficiency video coding (HEVC) standard.

This disclosure proposes structures and techniques for a fast implementation of an odd-type transform. The techniques of this disclosure will be described in general, and with reference to image and video coding. However, it should be understood that the fast implementation techniques of this disclosure are applicable for any use of an odd-type transform.

This disclosure proposes techniques for computing an odd-type transform on any real-valued sequence of data (e.g., residual values in a video coding process or a block of pixel values of an image coding process) by mapping the odd-type transform to a discrete Fourier transform (DFT). More specifically, this disclosure proposes a mapping between the real-valued data sequence to an intermediate sequence to be used as an input to a DFT. Using this intermediate sequence, an odd-type transform may be achieved by calculating a DFT of odd size. Conventionally known fast algorithms for a DFT may be used, and as such, the odd-type transform may be calculated in a fast manner.

The following will describe the solution for mapping DCTs and DSTs of type VI and VII to a DFT using an intermediate sequence. First, let x(n), n=0, . . . , N−1 represent a real-valued input data sequence (e.g., a sequence or matrix of residual values from intra-prediction in a video coding process). The discrete Fourier transform (DFT) and DCTs/DSTs of types II, III, VI and VI are defined over this sequence as follows:

$$\begin{matrix}DCT / DST of type II : & \\ {X}_{CII} ( k ) = {\sum }_{n = 0}^{N - 1} x ( n ) cos ( \frac{π ( n + 1 / 2 ) k}{N} ) ; \\ {X}_{SII} ( k ) = {\sum }_{n = 0}^{N - 1} x ( n ) sin ( \frac{π ( n + 1 / 2 ) k}{N} ) ; \\ k = 0 , … , N - 1 & ( 1 a ) \\ DCT / DST of type III \text{:} & \\ {X}_{CIII} ( k ) = {\sum }_{n = 0}^{N - 1} x ( n ) cos ( \frac{π ( k + 1 / 2 ) n}{N} ) ; \\ {X}_{SIII} ( k ) = {\sum }_{n = 0}^{N - 1} x ( n ) sin ( \frac{π ( k + 1 / 2 ) n}{N} ) ; \\ k = 0 , … , N - 1 & ( 2 a ) \\ DCT / DST of type VI \text{:} & \\ {X}_{CVI} ( k ) = {\sum }_{n = 0}^{N - 1} x ( n ) cos ( \frac{π ( 2 n + 1 ) ( k + 1 )}{2 N + 1} ) ; \\ {X}_{SVI} ( k ) = {\sum }_{n = 0}^{N - 1} x ( n ) sin ( \frac{π ( 2 n + 1 ) ( k + 1 )}{2 N + 1} ) ; \\ k = 0 , … , N - 1 & ( 3 a ) \\ DCT / DST of type VII \text{:} & \\ {X}_{CVII} ( k ) = {\sum }_{n = 0}^{N - 1} x ( n ) cos ( \frac{π ( 2 k + 1 ) ( n + 1 )}{2 N + 1} ) ; \\ {X}_{SVII} ( k ) = {\sum }_{n = 0}^{N - 1} x ( n ) sin ( \frac{π ( 2 k + 1 ) ( n + 1 )}{2 N + 1} ) ; \\ k = 0 , … , N - 1 & ( 4 a ) \\ DFT \text{:} & \\ {X}_{F} ( k ) = {\sum }_{n = 0}^{N - 1} X ( n ) {e}^{- j \frac{2 π nk}{N}} = {\sum }_{n = 0}^{N - 1} x ( n ) cos ( \frac{2 π nk}{N} ) - j {\sum }_{n = 0}^{N - 1} x ( n ) sin ( \frac{2 π nk}{N} ) ; \\ k = 0 , … , N - 1 & ( 5 a )\end{matrix}$$

For simplicity, in these definitions the usual normalization factors have been omitted (√\ddot{2}\ddot{/}\ddot{N} for type-II and III and 2/√\ddot{2}\ddot{N}\ddot{+}\ddot{1} for type VI and VII transforms).

The goal is to compute values X_{SVI} (n), n=0, . . . ,N−1, which is a DST of type VI of the input data sequence. Initially, consider first a case when the number of values in the input data sequence (i.e., N) is even. As one example, N could represent the block size of an image or video block to be coded (e.g., a 16×16 block). For an input data sequence x(n) with an even number of values, the disclosure proposes a mapping to an intermediate sequence y(n), n=0, . . . , 2N as follows:

$$y ( n ) = \{ \begin{matrix}0 , & if n = 0 , \\ - x ( 2 k + 1 ) , & if n = 1 + k , k = 0 , … , N / 2 - 1 , \\ - x ( 2 k ) & if n = N - k , k = 0 , … , N / 2 - 1 , \\ x ( 2 k ) & if n = N + 1 + k , k = 0 , … , N / 2 - 1 , \\ x ( 2 k + 1 ) , & if n = 2 N - k , k = 0 , … , N / 2 - 1.\end{matrix} \qquad ( 6 a )$$

In examples where the sequence of real-valued data has an odd number of values (e.g., an odd block sizes), a slightly different mapping for the intermediate sequence y(n), n=0, . . . , 2N is used:

$$y ( n ) = \{ \begin{matrix}0 , & if n = 0 , \\ - x ( 2 k + 1 ) , & if n = 1 + k , k = 0 , … , ( N - 1 ) / 2 - 1 , \\ - x ( 2 k ) & if n = N - k , k = 0 , … , ( N + 1 ) / 2 - 1 , \\ x ( 2 k ) & if n = N + 1 + k , k = 0 , … , ( N + 1 ) / 2 - 1 , \\ x ( 2 k + 1 ) , & if n = 2 N - k , k = 0 , … , ( N - 1 ) / 2 - 1.\end{matrix} \qquad ( 7 a )$$

Using either mapping for the intermediate sequence, let Y_{F}(k) be the DFT of the sequence y(n). Using the intermediate sequence y(n), a mapping between the DST of type VI and a DFT can be shown as follows:

Then:

$${X}_{SVI} ( k ) = \frac{1}{2} Im ( Y ( 2 k + 1 ) ) , \\ k = 0 , … , N - 1. \qquad ( 8 a )$$

In other words, an N-point DST of type VI can be mapped to a DFT of size 2N+1 (i.e., a DFT of odd length). The variable Y represents the sequence of values computed by the DFT, while the variable X represents the computed sequence of the odd-type transform (in this case, a DST of type VI). More specifically, using the mapping of the intermediate sequence y(n), a DST of type VI can be mapped to the imaginary values of a DFT of size 2N+1 at each 2k+1 index (i.e., each odd index). Since fast algorithms and fast factorizations are well known for DFTs (e.g., fast Fourier transforms (FFTs)), this mapping also allows for fast factorizations and fast algorithms for a DST of type VI. Three examples of fast algorithms that may be used are the Winograd algorithm for short prime lengths, the Winograd Fourier Transform Algorithm (WFTA), and prime factorization algorithm (PFA). A Winograd factorization of a DFT of length 9 has shown to perform well.

Similarly to the DST of type VI, the DCT of type VI can be obtained with the same mapping and results in a relationship to the real values of a DFT of size 2N+1 as follows:

$${X}_{CVI} ( k ) = \frac{1}{2} Re ( Y ( 2 k + 1 ) ) , \\ k = 0 , … , N - 1. \qquad ( 9 a )$$

An N-point DCT of type VI can be mapped to a DFT of size 2N+1 (i.e., a DFT of odd length). More specifically, using the mapping of the intermediate sequence y(n), a DCT of type VI can be mapped to the real values of a DFT of size 2N+1 at each 2k+1 index (i.e., each odd index). Again, since fast algorithms and fast factorizations are well known for DFTs (e.g., fast Fourier transforms (FFTs)), this mapping also allows for fast factorizations and fast algorithms for a DCT of type VI.

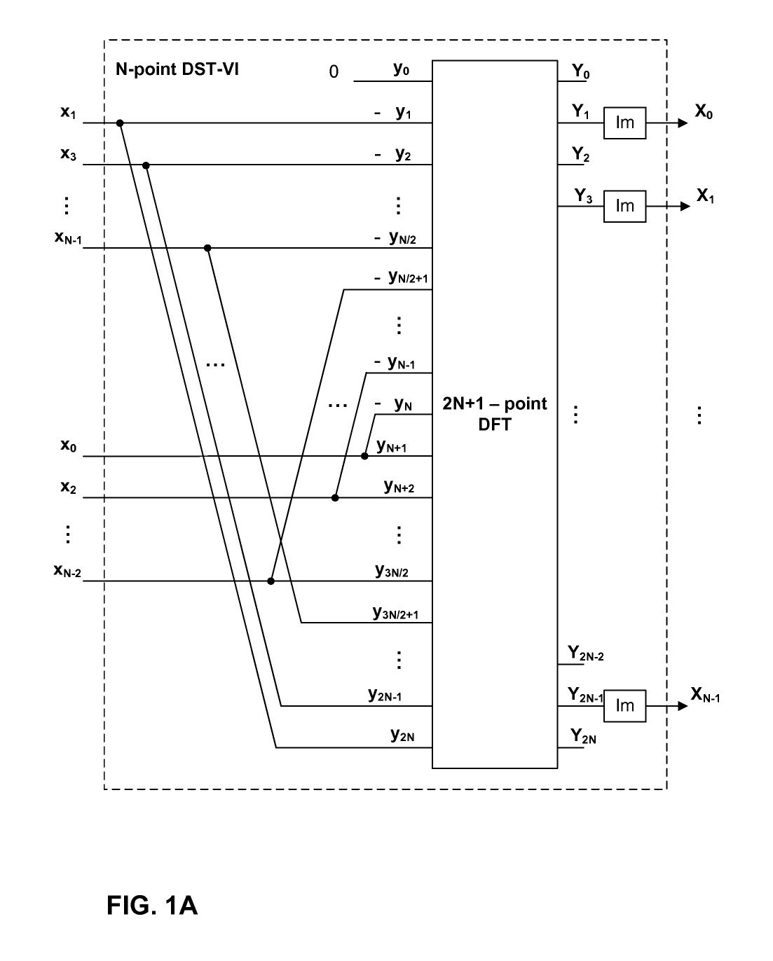

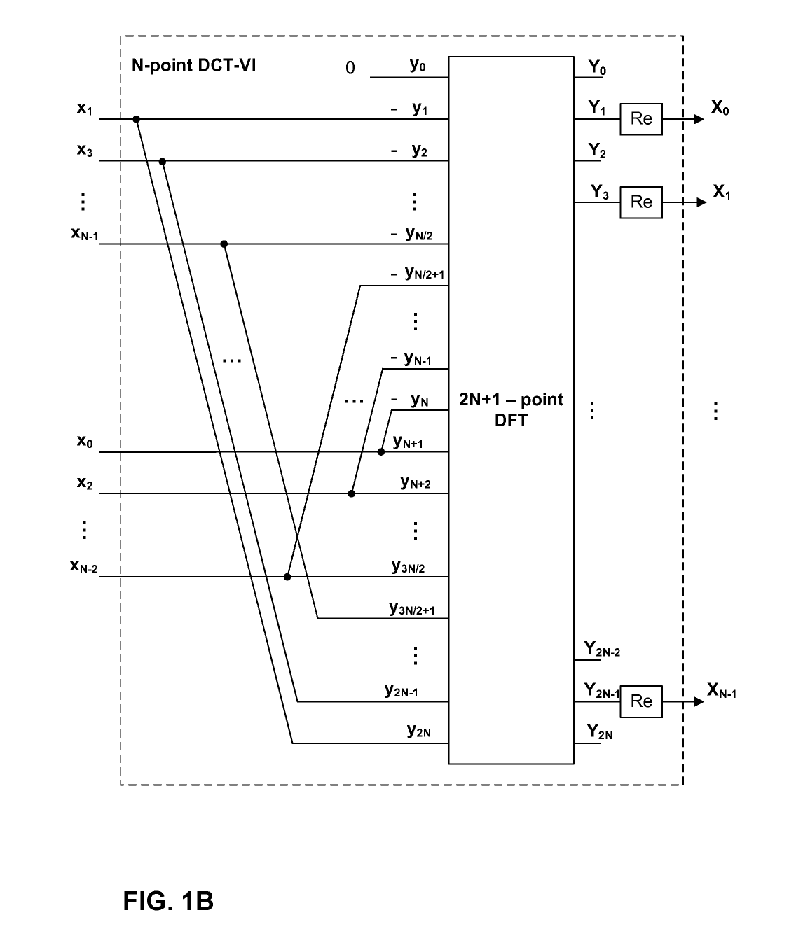

FIG. 1A shows a conceptual diagram of the mapping of the real-valued input sequence x(n) for DST of type VI to a DFT. Real-valued sequence x(n) is mapped to intermediate sequence y(n) according to one of the two mappings described above (i.e., equation (6a) for even numbered sequences and equation (7a) for odd numbered sequences). The intermediate sequence y(n) is then applied as the input to a 2N+1 point (i.e., odd length) DFT. The output of the 2N+1 point DFT is represented by variable Y. As shown in the proof above, and in equation (8a), the N-point DST of type VI is obtained by selecting the imaginary values of the DFT output Yat each odd index value. The values of the computed DST of type VI are represented by the variable X.

FIG. 1B shows a conceptual diagram of the mapping of the real-valued input sequence x(n) for DCT of type VI to a DFT. Real-valued sequence x(n) is mapped to intermediate sequence y(n) according to one of the two mappings described above (i.e., equation (6a) for even numbered sequences and equation (7a) for odd numbered sequences). The intermediate sequence y(n) is then applied as the input to a 2N+1 point (i.e., odd length) DFT. The output of the 2N+1 point DFT is represented by variable Y. As shown in the proof above, and in equation (9a), the N-point DCT of type VI is obtained by selecting the real values of the DFT output Y at each odd index value. The values of the computed DST of type VI are represented by the variable X

This disclosure has established the equivalence between N-point DST/DCT of type VI and real/imaginary values of a 2N+1-point DFT. In order to complete the construction of the transform, any suitable fast factorization of the DFT may be chosen and used with the diagram shown in FIG. 1. Fast factorization is a method by which a matrix is expressed as a product of two or more sparse matrices. The result is that the multiplication of the original matrix with a vector (another mathematical entity) can be computed much faster if the original matrix is substituted with the product of the sparse matrices. Fast computation is achieved because most of the entries in the sparse matrices are zeros. Examples of such fast factorizations include the Winograd algorithm for short prime lengths, the Winograd Fourier Transform Algorithm (WFTA), and prime factorization algorithm (PFA).

The DST/DCT of type VII is the inverse/transpose version of the DST/DCT of type VI. That is, a DST/DCT of type VI may be used to transform data in the time domain, to transformed data in the frequency domain. A DST/DCT of type VII may then be used to reverse this process by transforming data from the frequency domain back to the time domain. Fast factorizations for type-VII DCTs and DSTs may be obtained by simply reversing the direction of the mapping shown in FIGS. 1A and 1B. That is, inputs to DST/DCT of type VII arrive at the left of the DST/DCT of type VI shown in FIGS. 1A and 1B, meaning that the currently labeled outputs X₀-X_{N-1} in the example of FIGS. 1A and 1B become inputs, relabeled as x₀-x_{N-1}, respectively, while the currently labeled inputs x₀-x_{N-1} become outputs, relabeled X₀-X_{N-1}, respectively. Processing then flows from right to left when implementing DST/DCT of type VII inverse to the flow of processing when performing DST/DCT of type VI.

As mentioned above, the application of odd-type transforms may have many uses, including the transformation of data in image and video coding processes. In particular, odd-type transforms may be used in image and video compression.

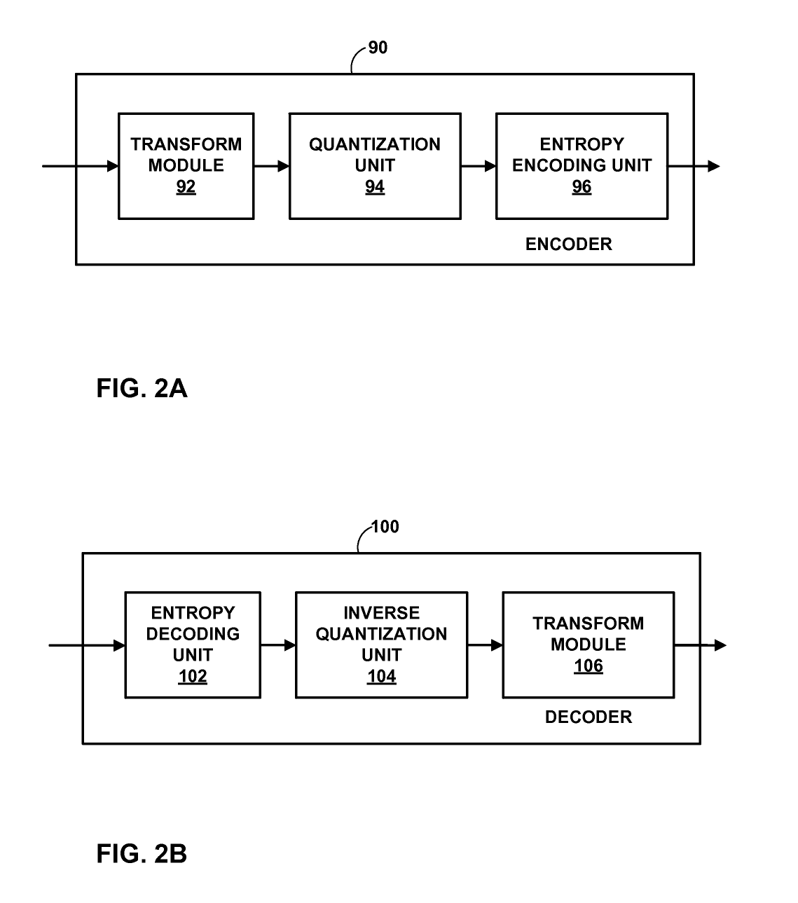

FIG. 2A is a block diagram illustrating a generalized example of an image or video encoder 90. A transform module 92 may be used to apply a transform (e.g., an odd-type transform such as the DCT/DST of type VI) to input data, such as pixels of an image or residual data from a predictive video coding process (e.g., inter-prediction or intra-prediction). The transform module 92 transforms the input data from the real domain into the frequency domain. This is typically done because much of the data in the frequency domain has a value of zero or a value very close to zero. Therefore, such a data set lends itself to further compression through run-length coding and/or statistical lossless coding (sometimes referred to as “entropy coding”). For example, much of the data from input pixels in the frequency domain (i.e., after it has been transformed) has a value of zero for higher frequency components. This is, for example, because many regions of an image have relatively homogenous values (e.g., chroma and luma values) across the image and there are not stark differences between pixels. A lack of these differences results in fewer non-zero values in the higher frequency components when transformed into the frequency domain.

The encoder 90 may further include a quantization unit 94 for quantizing the transformed data. In this context, quantizing involves converting a digital value at one bit-depth (e.g., 12 bits) to a digital value at a lower bit-depth (e.g., 8 bits). The amount of bit-depth reduction is often called a quantization parameter. Quantization allows for further compression of the input data and may also result in small-valued components in the frequency range to be quantized down to a value of zero. This leads to further efficiencies in compression when using statistical lossless coding. The quantized data may then be statistical lossless encoded by the statistical lossless encoding unit 96. Examples of statistical lossless coding include context adaptive variable length coding (CAVLC) and context adaptive binary arithmetic coding (CABAC).

FIG. 2B is a block diagram illustrating a generalized example of an image or video decoder 100. The decoder 100 may be used to reverse the process performed by the encoder 90 of FIG. 2A and retrieve the original input data. Decoder 100 includes a statistical lossless decoding unit 102. The statistical lossless decoding unit 102 may use a statistically lossless decoding algorithm that corresponds to the statistical lossless coding used at an encoder. Again, this may be CAVLC or CABAC. The decoder 100 may further include an inverse quantization unit 104 that inverses the quantization performed by an encoder. Finally, the transform module 106 applies an inverse transform (e.g., an odd-type inverse transform such as the DCT/DST of type VII) to recover the original input data.

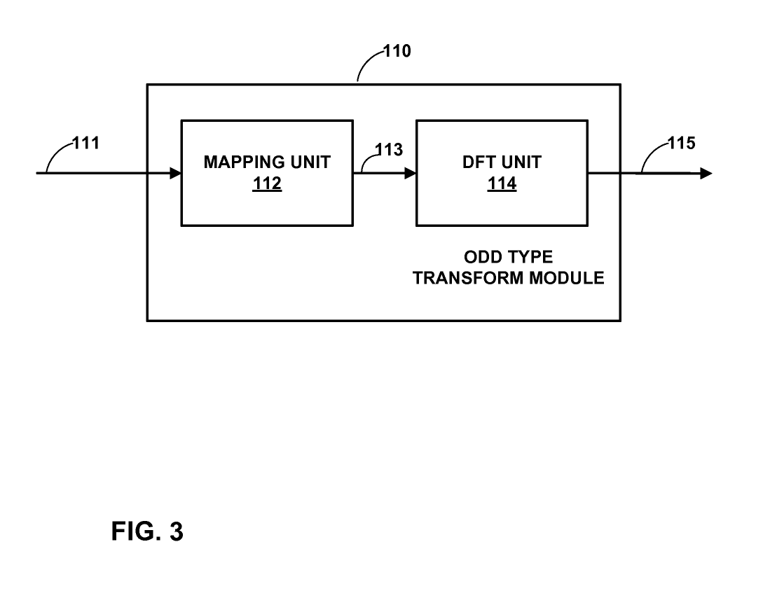

FIG. 3 is a block diagram illustrating an example odd-type transform module according to examples of this disclosure. This disclosure proposes that odd-type transforms are calculated by first mapping a sequence of real-valued data to an intermediate sequence and the performing a DFT on the intermediate sequence. FIG. 3 depicts an odd-type transform module 110 that includes a mapping unit 112 and a DFT unit 114. A sequence of real-valued data 111 is input to the mapping unit 112. The mapping unit 112 maps the real-valued data 111 to an intermediate sequence 113. For sequences of real-valued data 111 having an even number of values, the mapping unit 112 maps to the intermediate sequence 113 according to equation (6a) described above. For sequences of real-valued data 111 having an odd number of values, the mapping unit 112 maps to the intermediate sequence 113 according to equation (7a) described above.

The intermediate sequence is then used as an input to DFT unit 114. The DFT unit 114 may then calculate a DFT for the intermediate sequence using any applicable fast algorithm, such as a fast Fourier transform. In one example, the DFT unit 114 may be further configured to select only the imaginary part of odd numbered output values as the output for a DST of type VI (see equation (8a)). In another example, the DFT unit 114 may be further configured to select only the real part of odd numbered output values as the output for a DST of type VI (see equation (9a)). In either case, an odd-length DFT is used.

As mentioned above, the techniques for calculating an odd-type transform of this disclosure are applicable for application in video coding. One example application is the use of the DST of type VI for the transformation of residual values in an intra-prediction process for use with the high efficiency video coding (HEVC) standard currently under development by the Joint Cooperative Team for Video Coding (JCT-VC). The techniques of this disclosure are also applicable with other video compression techniques, such as those described in the standards defined by MPEG-2, MPEG-4, ITU-T H.263, ITU-T H.264/MPEG-4, Part 10, and Advanced Video Coding (AVC).

In HEVC, a video frame may be partitioned into coding units. A coding unit (CU) generally refers to an image region that serves as a basic unit to which various coding tools are applied for video compression. A CU usually has a luminance component, denoted as Y, and two chroma components, denoted as U and V. Depending on the video sampling format, the size of the U and V components, in terms of number of samples, may be the same as or different from the size of the Y component. A CU is typically square, and may be considered to be similar to a so-called macroblock, e.g., under other video coding standards such as ITU-T H.264. Coding according to some of the presently proposed aspects of the developing HEVC standard will be described in this application for purposes of illustration. However, the techniques described in this disclosure may be useful for other video coding processes, such as those defined according to H.264 or other standard or proprietary video coding processes.

HEVC standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-four intra-prediction encoding modes.

According to the HM, a CU may include one or more prediction units (PUs) and/or one or more transform units (TUs). Syntax data within a bitstream may define a largest coding unit (LCU), which is a largest CU in terms of the number of pixels. In general, a CU has a similar purpose to a macroblock of H.264, except that a CU does not have a size distinction. Thus, a CU may be split into sub-CUs. In general, references in this disclosure to a CU may refer to a largest coding unit of a picture or a sub-CU of an LCU. An LCU may be split into sub-CUs, and each sub-CU may be further split into sub-CUs. Syntax data for a bitstream may define a maximum number of times an LCU may be split, referred to as CU depth. Accordingly, a bitstream may also define a smallest coding unit (SCU). This disclosure also uses the term “block” or “portion” to refer to any of a CU, PU, or TU. In general, “block” or “portion” may refer to any sub-set of a video frame.

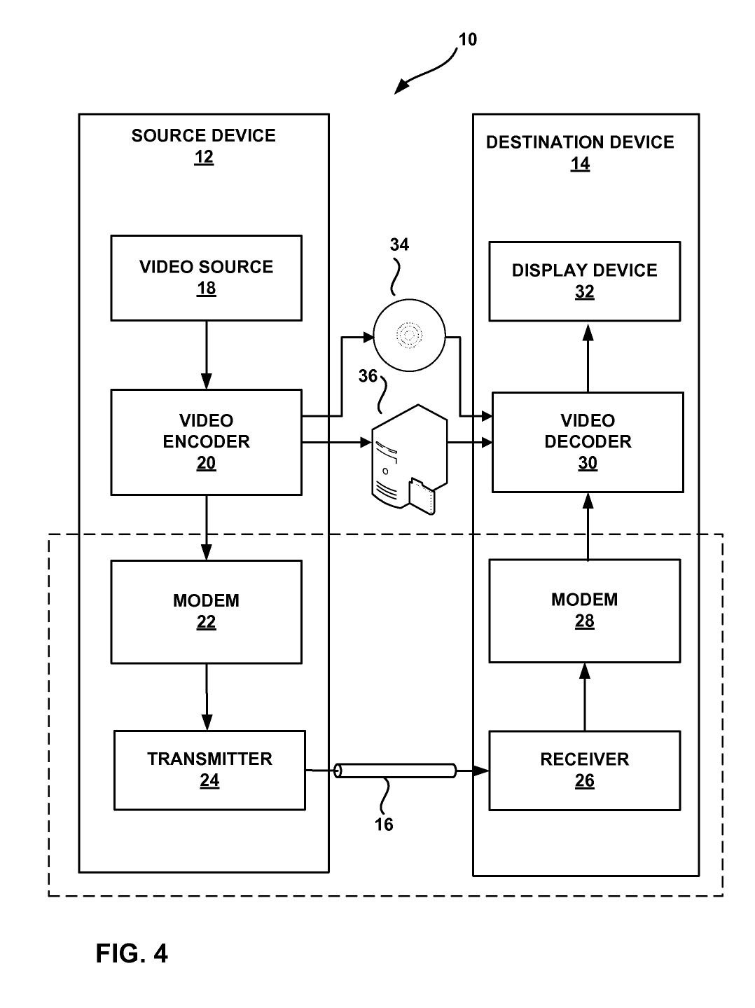

FIG. 4 is a block diagram illustrating an example video encoding and decoding system 10 that may be configured to utilize techniques for the fast computation of odd-type transforms for use in video coding in accordance with examples of this disclosure. As shown in FIG. 4, the system 10 includes a source device 12 that transmits encoded video to a destination device 14 via a communication channel 16. Encoded video may also be stored on a storage medium 34 or a file server 36 and may be accessed by the destination device 14 as desired. The source device 12 and the destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In many cases, such devices may be equipped for wireless communication. Hence, the communication channel 16 may comprise a wireless channel, a wired channel, or a combination of wireless and wired channels suitable for transmission of encoded video data. Similarly, the file server 36 may be accessed by the destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server.

Techniques for the fast computation of odd-type transforms, in accordance with examples of this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, the system 10 may be configured to support one-way or two-way video transmission to support applications such as video streaming, video playback, video broadcasting, and/or video telephony.

In the example of FIG. 4, the source device 12 includes a video source 18, a video encoder 20, a modulator/demodulator 22 and a transmitter 24. In the source device 12, the video source 18 may include a source such as a video capture device, such as a video camera, a video archive containing previously captured video, a video feed interface to receive video from a video content provider, and/or a computer graphics system for generating computer graphics data as the source video, or a combination of such sources. As one example, if the video source 18 is a video camera, the source device 12 and the destination device 14 may form so-called camera phones or video phones. However, the techniques described in this disclosure may be applicable to video coding in general, and may be applied to wireless and/or wired applications.

The captured, pre-captured, or computer-generated video may be encoded by the video encoder 20. The encoded video information may be modulated by the modem 22 according to a communication standard, such as a wireless communication protocol, and transmitted to the destination device 14 via the transmitter 24. The modem 22 may include various mixers, filters, amplifiers or other components designed for signal modulation. The transmitter 24 may include circuits designed for transmitting data, including amplifiers, filters, and one or more antennas.

The captured, pre-captured, or computer-generated video that is encoded by the video encoder 20 may also be stored onto a storage medium 34 or a file server 36 for later consumption. The storage medium 34 may include Blu-ray discs, DVDs, CD-ROMs, flash memory, or any other suitable digital storage media for storing encoded video. The encoded video stored on the storage medium 34 may then be accessed by the destination device 14 for decoding and playback.

The file server 36 may be any type of server capable of storing encoded video and transmitting that encoded video to the destination device 14. Example file servers include a web server (e.g., for a website), an FTP server, network attached storage (NAS) devices, a local disk drive, or any other type of device capable of storing encoded video data and transmitting it to a destination device. The transmission of encoded video data from the file server 36 may be a streaming transmission, a download transmission, or a combination of both. The file server 36 may be accessed by the destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on a file server.

The destination device 14, in the example of FIG. 4, includes a receiver 26, a modem 28, a video decoder 30, and a display device 32. The receiver 26 of the destination device 14 receives information over the channel 16, and the modem 28 demodulates the information to produce a demodulated bitstream for the video decoder 30. The information communicated over the channel 16 may include a variety of syntax information generated by the video encoder 20 for use by the video decoder 30 in decoding video data. Such syntax may also be included with the encoded video data stored on the storage medium 34 or the file server 36. Each of the video encoder 20 and the video decoder 30 may form part of a respective encoder-decoder (CODEC) that is capable of encoding or decoding video data.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In the example of FIG. 4, the communication channel 16 may comprise any wireless or wired communication medium, such as a radio frequency (RF) spectrum or one or more physical transmission lines, or any combination of wireless and wired media. The communication channel 16 may form part of a packet-based network, such as a local area network, a wide-area network, or a global network such as the Internet. The communication channel 16 generally represents any suitable communication medium, or collection of different communication media, for transmitting video data from the source device 12 to the destination device 14, including any suitable combination of wired or wireless media. The communication channel 16 may include routers, switches, base stations, or any other equipment that may be useful to facilitate communication from the source device 12 to the destination device 14.

The video encoder 20 and the video decoder 30 may operate according to a video compression standard, such as the High Efficiency Video Coding (HEVC) standard presently under development, and may conform to the HEVC Test Model (HM). Alternatively, the video encoder 20 and the video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples include MPEG-2 and ITU-T H.263.

Although not shown in FIG. 4, in some aspects, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

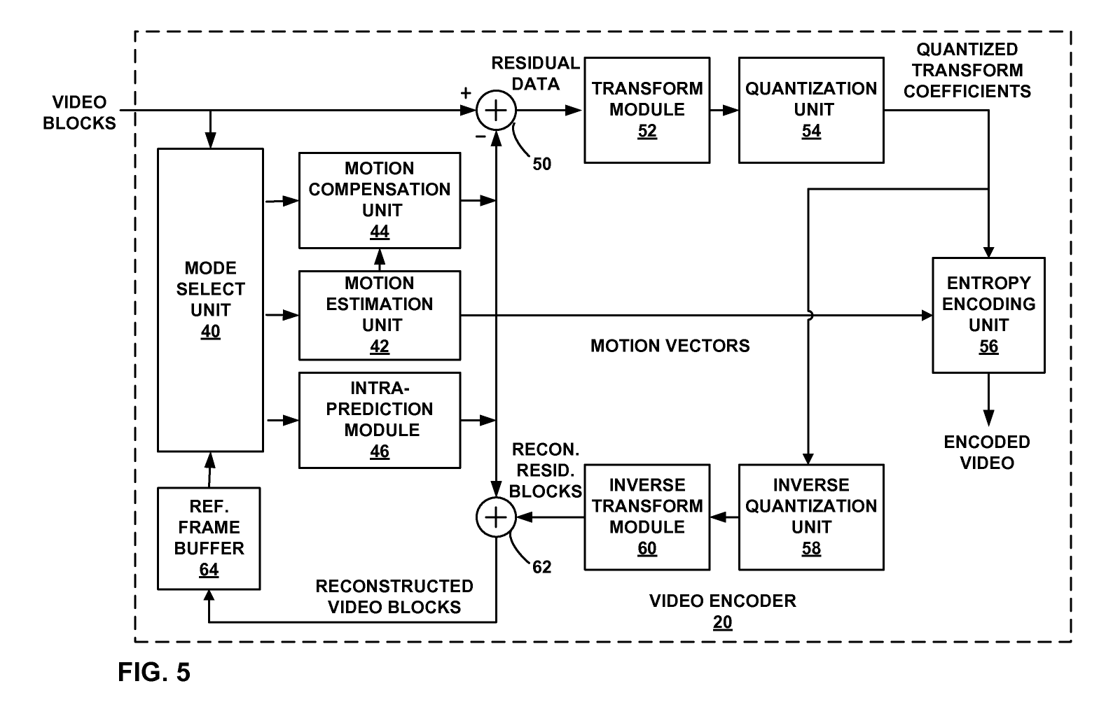

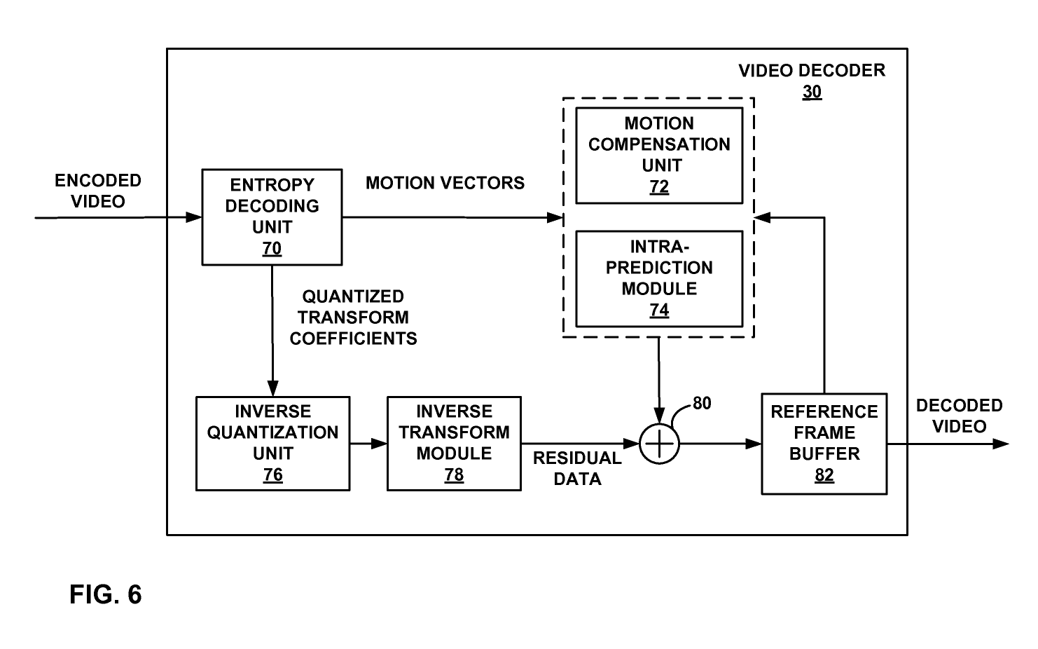

As will be discussed in more detail with reference to FIGS. 5-6, the video encoder 20 and the video decoder 30 may utilize transforms (e.g., odd-type transforms) to provide for greater compression of certain types of data. In particular, transforms are often used to provide for greater compression on residual data from a predictive video coding process (e.g., inter-prediction or intra-prediction).

The video encoder 20 may implement any or all of the techniques of this disclosure for the fast computation of odd-type transforms in a video coding process. Likewise, the video decoder 30 may implement any or all of these techniques for the fast computation of odd-type transforms in a video coding process. A video coder, as described in this disclosure, may refer to a video encoder or a video decoder. Similarly, a video coding unit may refer to a video encoder or a video decoder. Likewise, video coding may refer to video encoding or video decoding.

As such, in accordance with one example of this disclosure, a video coder (e.g., video encoder 20 or video decoder 30) may be configured to compute an odd-type discrete sine transform (DST) or discrete cosine transform (DCT) in a video or image coding process. The video coder comprising a coding module configured to receive a sequence of real-valued data on which to perform an odd-type transform, a mapping unit configured to map the sequence of real-valued data to an intermediate sequence, and a transform module configured to apply the intermediate sequence as an input to a discrete Fourier transform (DFT) to produce transformed data according to the odd-type transform. The odd-type transform comprises one of a DST of type V, a DCT of type V, a DST of type VI, a DCT of type VI, a DST of type VII, a DCT of type VII, a DST of type VIII, and a DCT of type VIII.

FIG. 5 is a block diagram illustrating an example of a video encoder 20 that may use techniques for the fast computation of odd-type transforms as described in this disclosure. The video encoder 20 will be described in the context of HEVC coding for purposes of illustration, but without limitation of this disclosure as to other coding standards or methods that use an odd-type transform. The video encoder 20 may perform intra- and inter-coding of CUs within video frames. Intra-coding relies on spatial prediction to reduce or remove spatial redundancy in video within a given video frame. Inter-coding relies on temporal prediction to reduce or remove temporal redundancy between a current frame and previously coded frames of a video sequence. Intra-mode (I-mode) may refer to any of several spatial-based video compression modes. Inter-modes such as uni-directional prediction (P-mode) or bi-directional prediction (B-mode) may refer to any of several temporal-based video compression modes.

As shown in FIG. 5, the video encoder 20 receives a current video block within a video frame to be encoded. In the example of FIG. 5, the video encoder 20 includes a motion compensation unit 44, a motion estimation unit 42, an intra-prediction module 46, a reference frame buffer 64, a summer 50, a transform module 52, a quantization unit 54, and an entropy encoding unit 56. The transform module 52 illustrated in FIG. 5 is the unit that applies the actual transform (e.g., an odd-type transform) or combinations of transform to a block of residual data, and is not to be confused with block of transform coefficients, which also may be referred to as a transform unit (TU) of a CU. For video block reconstruction, the video encoder 20 also includes an inverse quantization unit 58, an inverse transform module 60, and a summer 62. A deblocking filter (not shown in FIG. 5) may also be included to filter block boundaries to remove blockiness artifacts from reconstructed video. If desired, the deblocking filter would typically filter the output of the summer 62.

During the encoding process, the video encoder 20 receives a video frame or slice to be coded. The frame or slice may be divided into multiple video blocks, e.g., largest coding units (LCUs). The motion estimation unit 42 and the motion compensation unit 44 perform inter-predictive coding of the received video block relative to one or more blocks in one or more reference frames to provide temporal compression. The intra-prediction module 46 may perform intra-predictive coding of the received video block relative to one or more neighboring blocks in the same frame or slice as the block to be coded to provide spatial compression.

The mode select unit 40 may select one of the coding modes, intra or inter, e.g., based on error (i.e., distortion) results for each mode, and provides the resulting intra- or inter-coded block to the summer 50 to generate residual block data and to the summer 62 to reconstruct the encoded block for use in a reference frame. Some video frames may be designated as I-frames, where all blocks in an I-frame are encoded in an intra-prediction mode. In some cases, the intra-prediction module 46 may perform intra-prediction encoding of a block in a P- or B-frame, e.g., when motion search performed by the motion estimation unit 42 does not result in a sufficient prediction of the block.

The motion estimation unit 42 and the motion compensation unit 44 may be highly integrated, but are illustrated separately for conceptual purposes. Motion estimation is the process of generating motion vectors, which estimate motion for video blocks. A motion vector, for example, may indicate the displacement of a prediction unit in a current frame relative to a reference sample of a reference frame. A reference sample may be a block that is found to closely match the portion of the CU including the PU being coded in terms of pixel difference, which may be determined by sum of absolute difference (SAD), sum of square difference (SSD), or other difference metrics. Motion compensation, performed by the motion compensation unit 44, may involve fetching or generating values for the prediction unit based on the motion vector determined by motion estimation. Again, the motion estimation unit 42 and the motion compensation unit 44 may be functionally integrated, in some examples.

The motion estimation unit 42 calculates a motion vector for a prediction unit of an inter-coded frame by comparing the prediction unit to reference samples of a reference frame stored in the reference frame buffer 64. In some examples, the video encoder 20 may calculate values for sub-integer pixel positions of reference frames stored in the reference frame buffer 64. For example, the video encoder 20 may calculate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision. The motion estimation unit 42 sends the calculated motion vector to the entropy encoding unit 56 and the motion compensation unit 44. The portion of the reference frame identified by a motion vector may be referred to as a reference sample. The motion compensation unit 44 may calculate a prediction value for a prediction unit of a current CU, e.g., by retrieving the reference sample identified by a motion vector for the PU.

The intra-prediction module 46 may intra-prediction encode the received block, as an alternative to inter-prediction performed by the motion estimation unit 42 and the motion compensation unit 44. The intra-prediction module 46 may encode the received block relative to neighboring, previously coded blocks, e.g., blocks above, above and to the right, above and to the left, or to the left of the current block, assuming a left-to-right, top-to-bottom encoding order for blocks. The intra-prediction module 46 may be configured with a variety of different intra-prediction modes. For example, the intra-prediction module 46 may be configured with a certain number of directional prediction modes, e.g., 33 directional prediction modes, based on the size of the CU being encoded.

The intra-prediction module 46 may select an intra-prediction mode by, for example, calculating error values for various intra-prediction modes and selecting a mode that yields the lowest error value. Directional prediction modes may include functions for combining values of spatially neighboring pixels and applying the combined values to one or more pixel positions in a PU. Once values for all pixel positions in the PU have been calculated, the intra-prediction module 46 may calculate an error value for the prediction mode based on pixel differences between the PU and the received block to be encoded. The intra-prediction module 46 may continue testing intra-prediction modes until an intra-prediction mode that yields an acceptable error value is discovered. The intra-prediction module 46 may then send the PU to the summer 50.

The video encoder 20 forms a residual block by subtracting the prediction data calculated by the motion compensation unit 44 or the intra-prediction module 46 from the original video block being coded. The summer 50 represents the component or components that perform this subtraction operation. The residual block may correspond to a two-dimensional matrix of pixel difference values, where the number of values in the residual block is the same as the number of pixels in the PU corresponding to the residual block. The values in the residual block may correspond to the differences, i.e., error, between values of co-located pixels in the PU and in the original block to be coded. The differences may be chroma or luma differences depending on the type of block that is coded. This residual block may then be transformed by the transform module 52 according to the techniques of this disclosure. That is, the residual block is used as the real-valued input data sequence. Typically, a residual block is of even length, though odd length residual blocks are also possible.

The transform module 52 may form one or more transform units (TUs) from the residual block. The transform module 52 selects a transform from among a plurality of transforms. In some examples, the transform module 52 may select an odd-type transform implemented in accordance with techniques described in this disclosure. The transform module 52 then applies the selected transform or transforms to the TU, producing a video block comprising a two-dimensional array of transform coefficients. In particular, transform module 52 may be configured to apply an odd-type transform in the same manner as the odd-type transform module 110 of FIG. 3 as described above.

The transform module 52, or another unit of the video encoder, may signal the transform used in the encoded video bitstream for use by a video decoder (e.g., the video decoder 30 in FIG. 4). In this context, signaling the transform(s) in the encoded bitstream does not require real-time transmission of such elements from the encoder to a decoder, but rather means that such syntax elements are encoded into the bitstream and are made accessible to the decoder in any fashion. This may include real-time transmission (e.g., in video conferencing) as well as storing the encoded bitstream including the syntax elements on a computer-readable medium for future use by a decoder (e.g., in streaming, downloading, disk access, card access, DVD, Blu-ray, etc.).

The transform module 52 may send the resulting transform coefficients to the quantization unit 54. The quantization unit 54 may then quantize the transform coefficients. The entropy encoding unit 56 may then perform a scan of the quantized transform coefficients in the matrix according to a scanning mode. This disclosure describes the entropy encoding unit 56 as performing the scan. However, it should be understood that, in other examples, other processing units, such as the quantization unit 54, could perform the scan.

Once the transform coefficients are scanned into the one-dimensional array, the entropy encoding unit 56 may apply entropy coding such as CAVLC, CABAC, syntax-based context-adaptive binary arithmetic coding (SBAC), or another entropy coding methodology to the coefficients. In addition, the entropy encoding unit 56 may encode motion vector (MV) information and any of a variety of syntax elements useful in decoding the video data at the video decoder 30.

To perform CAVLC, the entropy encoding unit 56 may select a variable length code for a symbol to be transmitted. Codewords in VLC may be constructed such that relatively shorter codes correspond to more likely symbols, while longer codes correspond to less likely symbols. In this way, the use of VLC may achieve a bit savings over, for example, using equal-length codewords for each symbol to be transmitted.

To perform CABAC, the entropy encoding unit 56 may select a context model to apply to a certain context to encode symbols to be transmitted. The context may relate to, for example, whether neighboring values are non-zero or not. The entropy encoding unit 56 may also entropy encode syntax elements, such as a significant coefficient flag and a last coefficient flag produced when performing an adaptive scan. In accordance with the techniques of this disclosure, the entropy encoding unit 56 may select the context model used to encode these syntax elements based on, for example, an intra-prediction direction, a scan position of the coefficient corresponding to the syntax elements, block type, and/or transform type, among other factors used for context model selection.

Following the entropy coding by the entropy encoding unit 56, the resulting encoded video may be transmitted to another device, such as the video decoder 30, or archived for later transmission or retrieval.

The inverse quantization unit 58 and the inverse transform module 60 apply inverse quantization and inverse transformation, respectively, to reconstruct the residual block in the pixel domain, e.g., for later use as a reference block. As one example, the inverse quantization unit 58 may apply an inverse odd-type transform, such as a DCT or DST of type VII. The motion compensation unit 44 may calculate a reference block by adding the residual block to a predictive block of one of the frames of the reference frame buffer 64. The motion compensation unit 44 may also apply one or more interpolation filters to the reconstructed residual block to calculate sub-integer pixel values for use in motion estimation. The summer 62 adds the reconstructed residual block to the motion compensated prediction block produced by the motion compensation unit 44 to produce a reconstructed video block for storage in the reference frame buffer 64. The reconstructed video block may be used by the motion estimation unit 42 and the motion compensation unit 44 as a reference block to inter-code a block in a subsequent video frame.

FIG. 6 is a block diagram illustrating an example of a video decoder 30, which decodes an encoded video sequence. In the example of FIG. 6, the video decoder 30 includes an entropy decoding unit 70, a motion compensation unit 72, an intra-prediction module 74, an inverse quantization unit 76, an inverse transformation unit 78, a reference frame buffer 82 and a summer 80. The video decoder 30 may, in some examples, perform a decoding pass generally, reciprocal to the encoding pass described with respect to the video encoder 20 (see FIG. 5).

The entropy decoding unit 70 performs an entropy decoding process on the encoded bitstream to retrieve a one-dimensional array of transform coefficients. The entropy decoding process used depends on the entropy coding used by the video encoder 20 (e.g., CABAC, CAVLC, etc.). The entropy coding process used by the encoder may be signaled in the encoded bitstream or may be a predetermined process.

In some examples, the entropy decoding unit 70 (or the inverse quantization unit 76) may scan the received values using a scan mirroring the scanning mode used by the entropy encoding unit 56 (or the quantization unit 54) of the video encoder 20. Although the scanning of coefficients may be performed in the inverse quantization unit 76, scanning will be described for purposes of illustration as being performed by the entropy decoding unit 70. In addition, although shown as separate functional units for ease of illustration, the structure and functionality of the entropy decoding unit 70, the inverse quantization unit 76, and other units of the video decoder 30 may be highly integrated with one another.

The entropy decoding unit 70 applies the scanning mode to the one-dimensional array of transform coefficients to generate a two-dimensional array of transform coefficients. The two-dimensional array of transform coefficients produced by the entropy decoding unit 70 may still be in quantized form and may generally match the two-dimensional array of transform coefficients scanned by the entropy encoding unit 56 of the video encoder 20.

The inverse quantization unit 76 inverse quantizes, i.e., de-quantizes, the quantized transform coefficients provided in the bitstream and decoded by the entropy decoding unit 70. The inverse quantization process may include a conventional process, e.g., similar to the processes proposed for HEVC or defined by the H.264 decoding standard. The inverse quantization process may include use of a quantization parameter QP calculated by the video encoder 20 for the CU to determine a degree of quantization and, likewise, a degree of inverse quantization that should be applied. The inverse quantization unit 76 may inverse quantize the transform coefficients either before or after the coefficients are converted from a one-dimensional array to a two-dimensional array.

The inverse transform module 58 applies an inverse transform, such as an odd-type inverse transform (e.g., a DST or DCT of type VII). In some examples, the inverse transform module 78 may determine an inverse transform based on signaling from the video encoder 20 as described above, or by inferring the transform from one or more coding characteristics such as block size, coding mode, or the like. In some examples, the inverse transform module 78 may determine a transform to apply to the current block based on a signaled transform at the root node of a quadtree for an LCU including the current block. Alternatively, the transform may be signaledat the root of a TU quadtree for a leaf-node CU in the LCU quadtree.

The motion compensation unit 72 may generate prediction data based on motion vectors received from the entropy decoding unit 70. The intra-prediction module 74 may generate prediction data for a current block of a current frame based on a signaled intra-prediction mode and data from previously decoded blocks of the current frame.

The motion compensation unit 72 produces motion compensated blocks, possibly performing interpolation based on interpolation filters. Identifiers for interpolation filters to be used for motion estimation with sub-pixel precision may be included in the syntax elements. The motion compensation unit 72 may use interpolation filters as used by the video encoder 20 during encoding of the video block to calculate interpolated values for sub-integer pixels of a reference block. The motion compensation unit 72 may determine the interpolation filters used by the video encoder 20 according to received syntax information and use the interpolation filters to produce predictive blocks.

The motion compensation unit 72 and the intra-prediction module 74, in an HEVC example, may use some of the syntax information (e.g., provided by a quadtree) to determine sizes of LCUs used to encode frame(s) of the encoded video sequence. The motion compensation unit 72 and the intra-prediction module 74 may also use syntax information to determine split information that describes how each CU of a frame of the encoded video sequence is split (and likewise, how sub-CUs are split). The syntax information may also include modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence.

The summer 80 combines the residual blocks with the corresponding prediction blocks generated by the motion compensation unit 72 or the intra-prediction module 74 to form decoded blocks. If desired, a deblocking filter may also be applied to filter the decoded blocks in order to remove blockiness artifacts. The decoded video blocks are then stored in the reference frame buffer 82, which provides reference blocks for subsequent motion compensation and also produces decoded video for presentation on a display device (such as the display device 32 of FIG. 4).

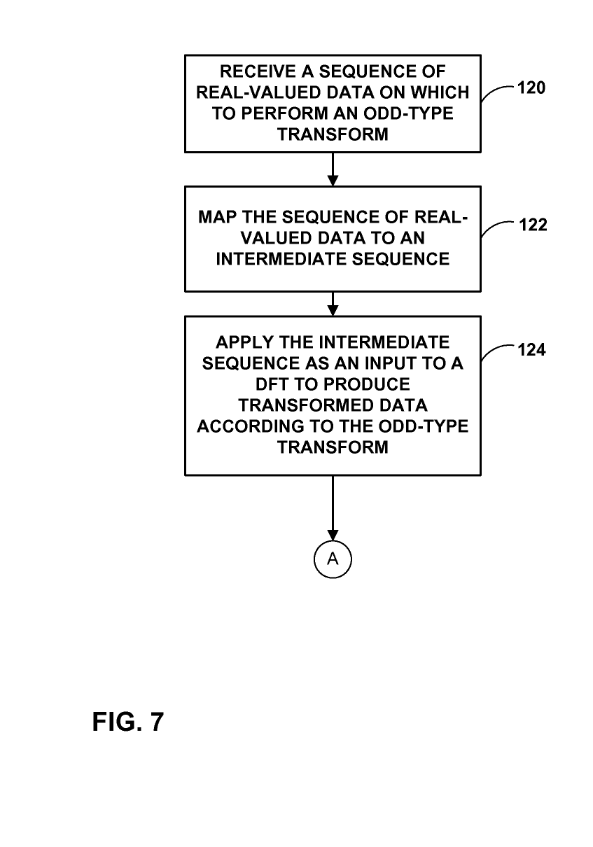

FIG. 7 is a flowchart illustrating an example process for performing an odd-type transform. The video encoder 20 of FIG. 5 and/or the video decoder 30 of FIG. 6 may perform the process illustrated in the example of FIG. 7. Initially, the video encoder 20 or the video decoder 30 receives a sequence of real-valued data on which to perform an odd-type transform (120). The sequence of real-valued data may be pixels of image data. Additionally, the sequence of real-valued data may be video data, such as residual data from a prediction process (e.g., in video encoding) or transform coefficients (e.g., in video decoding).

Next, the video encoder 20 or the video decoder 30 maps the sequence of real-valued data to an intermediate sequence (122). In one example, the sequence of real-valued data has an even number of values and is represented by x(n), wherein an individual value of the sequence of real-valued data is denoted as x(n) with variable n representing an index associated with the individual value of the sequence of real-valued data. The intermediate sequence is denoted by the variable y, wherein an individual value of the sequence is denoted as y(n) with variable n representing an index associated with the individual value of the intermediate sequence. The sequence of real-valued data is mapped to the intermediate sequence using equation (6):

$$y ( n ) = \{ \begin{matrix}0 , & if n = 0 , \\ - x ( 2 k + 1 ) , & if n = 1 + k , k = 0 , … , N / 2 - 1 , \\ - x ( 2 k ) & if n = N - k , k = 0 , … , N / 2 - 1 , \\ x ( 2 k ) & if n = N + 1 + k , k = 0 , … , N / 2 - 1 , \\ x ( 2 k + 1 ) , & if n = 2 N - k , k = 0 , … , N / 2 - 1.\end{matrix} \qquad ( 6 )$$

For an example where the sequence of real-valued data has an odd number values, the real-sequence of real-valued data is mapped to the intermediate sequence using equation (7):

$$y ( n ) = \{ \begin{matrix}0 , & if n = 0 , \\ - x ( 2 k + 1 ) , & if n = 1 + k , k = 0 , … , ( N - 1 ) / 2 - 1 , \\ - x ( 2 k ) & if n = N - k , k = 0 , … , ( N + 1 ) / 2 - 1 , \\ x ( 2 k ) & if n = N + 1 + k , k = 0 , … , ( N + 1 ) / 2 - 1 , \\ x ( 2 k + 1 ) , & if n = 2 N - k , k = 0 , … , ( N - 1 ) / 2 - 1.\end{matrix} \qquad ( 7 )$$

After the intermediate sequence is create, the video encoder 20 or the video decoder 30 applies the intermediate sequence as an input to a discrete Fourier transform (DFT) to produce transformed data according to the odd-type transform (124). The odd-type transform may be one of a DST of type V, a DCT of type V, a DST of type VI, a DCT of type VI, a DST of type VII, a DCT of type VII, a DST of type VIII, and a DCT of type VIII. As one example, the odd-type transform is a DST of type VI. In this example, a DST of type VI applied to the sequence of real-valued data may be represented as imaginary values of a DFT of odd size using the intermediate sequence y(n). As such, the DST of type VI may be represented by:

$${X}_{SVI} ( k ) = \frac{1}{2} Im ( Y ( 2 k + 1 ) ) , \\ k = 0 , … , N - 1.$$

The variable Y refers to a sequence of DFT output values computed by the DFT.

In another example, the odd-type transform is a DCT of type VI. In this example, a DCT of type VI applied to the sequence of real-valued data may be represented as real values of a DFT of odd size using the intermediate sequence y(n). As such, the DCT of type VI may be represented by:

$${X}_{CVI} ( k ) = \frac{1}{2} Re ( Y ( 2 k + 1 ) ) , \\ k = 0 , … , N - 1.$$

A fast DFT algorithm may be used to compute the odd-type transform using the aforementioned mapping of equations (6) or (7). In one example, the fast algorithm may be a fast Fourier transform (FFT).

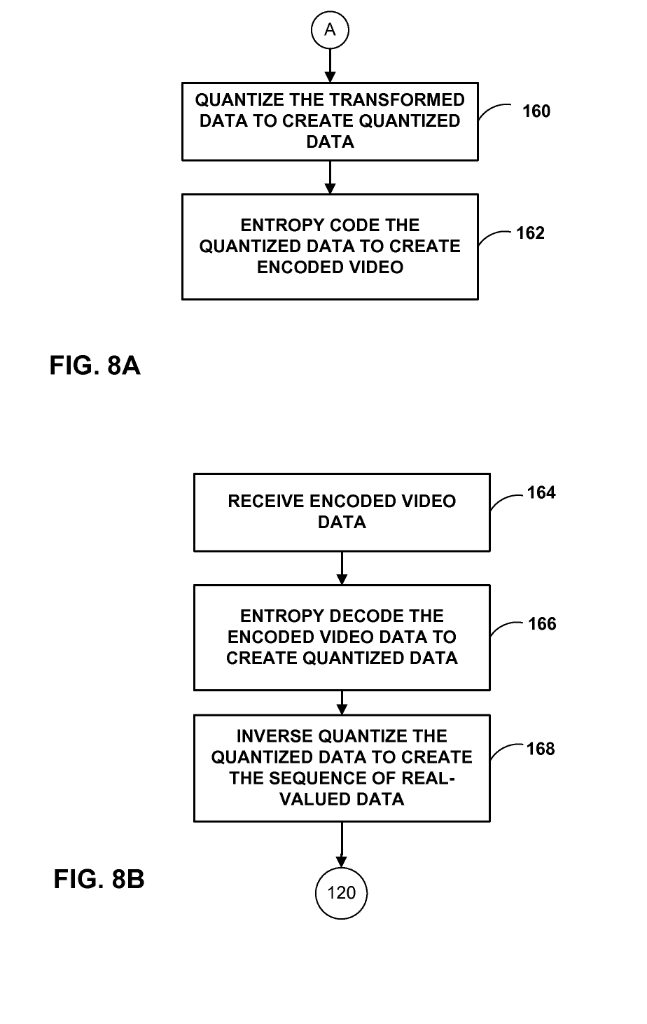

FIG. 8A is a flowchart illustrating an example process for performing an odd-type transform in a video coding process. In the example of FIG. 8A, the video coding process is an encoding process and the sequence of real-valued data is residual data from a predictive video coding process (e.g., intra-prediction or inter-prediction). In one example, the video coding process is an intra-prediction process using a DST of type VI, however, any odd-type transform may be used. As such, in this example, the transformed data produced by the process of FIG. 7 would be transform coefficients as explained above with reference to FIG. 5.

In the example of FIG. 8A, steps 120, 122, 124 are first performed by the video encoder 20 as described above reference to FIG. 7. The video encoder 20 may further quantize the transformed data to create quantized data (160) and performs statistical lossless coding on the quantized data to create encoded video (162).

FIG. 8B is a flow chart illustrating an example process for performing an odd-type transform in a video coding process. In the example of FIG. 8B, the video coding process is a decoding process and the sequence of real-valued data are transform coefficients as was explained above with reference to FIG. 6. The transform coefficients may be transformed into residual data using the process of FIG. 7 (i.e., the transformed data of FIG. 7 is residual data in this example). As such, in the example of FIG. 8B, the odd-type transform may be an inverse transform, such as a DST of type VII. However, any odd-type transform that is the inverse of the odd-type transform used to encode the video data may be used.

FIG. 8B shows the method of producing the sequence of real-valued data (i.e., in this example, transform coefficients) from an encoded video bitstream. Video decoder 30 receives the encoded video data (164), performs statistical lossless decoding on the encoded video data to create quantized data (166), and inverse quantizes the quantized data to create the sequence of real-valued data (168). In the example of FIG. 8B, steps 120, 122, 124 are then performed by the video decoder 30 as described above reference to FIG. 7.

The following paragraphs show one example of the derivation of the intermediate sequence discussed above. Though the following derivation uses different variables, one skilled in the art would understand how the following techniques may be used to derive the intermediate sequence shown above.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for computing an odd-type discrete sine transform (DST) or discrete cosine transform (DCT) in a video or image coding process comprising:
receiving a sequence of real-valued data on which to perform an odd-type transform;
mapping the sequence of real-valued data to an intermediate sequence; and
applying the intermediate sequence as an input to a discrete Fourier transform (DFT) to produce transformed data according to the odd-type transform, wherein the odd-type transform comprises one of a DST of type V, a DCT of type V, a DST of type VI, a DCT of type VI, a DST of type VII, a DCT of type VII, a DST of type VIII, and a DCT of type VIII.

2. The method of claim 1, wherein the sequence of real-valued data is a sequence of image data.

3. The method of claim 2, wherein the odd-type transform is a DST of type VI or a DST of type VII, and wherein the sequence of image data is a sequence of residual values from a prediction process in video coding.

4. The method of claim 3, further comprising:
quantizing the transformed data to create quantized data; and
perform statistical lossless coding on the quantized data to create encoded video.

5. The method of claim 2, further comprising:
receiving encoded video data;
perform statistical lossless coding decoding on the encoded video data to create quantized data; and
inverse quantizing the quantized data to create the sequence of real-valued data,
wherein the odd-type transform is a DST of type VI or a DST of type VII, and wherein the transformed data is residual video data.

6. The method of claim 1,
wherein the sequence of real-valued data has an even number of values and is represented by x(n), wherein an individual value of the sequence of real-valued data is denoted as x(n) with variable n representing an index associated with the individual value of the sequence of real-valued data;
wherein the intermediate sequence is denoted by the variable y, wherein an individual value of the sequence is denoted as y(n) with variable n representing an index associated with the individual value of the intermediate sequence, and
wherein mapping the sequence of real-valued data comprises mapping the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , N / 2 - 1 , \\ - x ( 2 k ) & if n = N - k , k = 0 , … , N / 2 - 1 , \\ x ( 2 k ) & if n = N + 1 + k , k = 0 , … , N / 2 - 1 , \\ x ( 2 k + 1 ) , & if n = 2 N - k , k = 0 , … , N / 2 - 1.\end{matrix}$$

7. The method of claim 6,
wherein the odd-type transform comprises the DST of type VI,
wherein the DST of type VI applied to the sequence of real-valued data is represented as imaginary values of a DFT of odd size using the intermediate sequence y(n), the DST of type VI represented by
$${X}_{SVI} ( k ) = \frac{1}{2} Im ( Y ( 2 k + 1 ) ) , k = 0 , … , N - 1 ,$$
and
wherein the variable Y refers to a sequence of DFT output values computed by the DFT.

8. The method of claim 7, wherein applying the intermediate sequence as an input to a discrete Fourier transform (DFT) to produce transformed data according to the DST of type VI comprises applying a fast DFT algorithm to compute the sequence
$${X}_{SVI} ( k ) = \frac{1}{2} Im ( Y ( 2 k + 1 ) ) , k = 0 , … , N - 1. .$$

9. The method of claim 8, wherein the fast algorithm is a fast Fourier transform (FFT) algorithm.

10. The method of claim 8, wherein the fast algorithm is a Winograd DFT module of length 9.

11. The method of claim 6,
wherein the odd-type transform is a DCT of type VI,
wherein a DCT of type VI applied to the sequence of real-valued data is represented as real values of a DFT of odd size using the intermediate sequence y(n), the DCT of type VI represented by
$${X}_{CVI} ( k ) = \frac{1}{2} Re ( Y ( 2 k + 1 ) ) , k = 0 , … , N - 1. ,$$
and
wherein the variable Y refers to a sequence of DFT output values computed by the DFT.

12. The method of claim 11, wherein applying the intermediate sequence as an input to a discrete Fourier transform (DFT) to produce transformed data according to the DCT of type VI comprises applying a fast DFT algorithm to compute the sequence
$${X}_{CVI} ( k ) = \frac{1}{2} Re ( Y ( 2 k + 1 ) ) , \\ k = 0 , … , N - 1.$$

13. The method of claim 1, wherein the sequence of real-valued data has an odd number of values and is represented by x(n), wherein an individual value of the sequence of real-valued data is denoted as x(n) with variable n representing an index associated with the individual value of the sequence of real-valued data,
wherein the intermediate sequence is denoted by the variable y, wherein an individual value of the sequence is denoted as y(n) with variable n representing an index associated with the individual value of the intermediate sequence, and
wherein mapping the sequence of real-valued data comprises mapping the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , ( N - 1 ) / 2 - 1 , \\ - x ( 2 k ) & if n = N - k , k = 0 , … , ( N + 1 ) / 2 - 1 , \\ x ( 2 k ) & if n = N + 1 + k , k = 0 , … , ( N + 1 ) / 2 - 1 , \\ x ( 2 k + 1 ) , & if n = 2 N - k , k = 0 , … , ( N - 1 ) / 2 - 1.\end{matrix}$$

14. An apparatus configured to compute an odd-type discrete sine transform (DST) or discrete cosine transform (DCT) in a video or image coding process comprising:
a coding module configured to receive a sequence of real-valued data on which to perform an odd-type transform;
a mapping unit configured to map the sequence of real-valued data to an intermediate sequence; and
a transform module configured to apply the intermediate sequence as an input to a discrete Fourier transform (DFT) to produce transformed data according to the odd-type transform, wherein the odd-type transform comprises one of a DST of type V, a DCT of type V, a DST of type VI, a DCT of type VI, a DST of type VII, a DCT of type VII, a DST of type VIII, and a DCT of type VIII.

15. The apparatus of claim 14, wherein the sequence of real-valued data is a sequence of image data.

16. The apparatus of claim 15, wherein the odd-type transform is a DST of type VI or a DST of type VII, and wherein the sequence of image data is a sequence of residual values from a prediction process in video coding.

17. The apparatus of claim 16, further comprising:
a quantization unit configured to quantize the transformed data to create quantized data; and
a statistical lossless encoding unit configured to statistical lossless code the quantized data to create encoded video.

18. The apparatus of claim 15, further comprising:
a decoding unit configured to receive encoded video data;
a statistical lossless decoding unit configured to statistical lossless decode the encoded video data to create quantized data; and
an inverse quantization unit configured to inverse quantize the quantized data to create the sequence of real-valued data, wherein the odd-type transform is a DST of type VI or a DST of type VII, and wherein the transformed data is residual video data.

19. The apparatus of claim 14,
wherein the sequence of real-valued data has an even number of values and is represented by x(n), wherein an individual value of the sequence of real-valued data is denoted as x(n) with variable n representing an index associated with the individual value of the sequence of real-valued data,
wherein the intermediate sequence is denoted by the variable y, wherein an individual value of the sequence is denoted as y(n) with variable n representing an index associated with the individual value of the intermediate sequence, and
wherein the mapping unit is further configured to map the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , N / 2 - 1 , \\ - x ( 2 k ) & if n = N - k , k = 0 , … , N / 2 - 1 , \\ x ( 2 k ) & if n = N + 1 + k , k = 0 , … , N / 2 - 1 , \\ x ( 2 k + 1 ) , & if n = 2 N - k , k = 0 , … , N / 2 - 1.\end{matrix}$$

20. The apparatus of claim 19,
wherein the odd-type transform comprises the DST of type VI,
wherein the DST of type VI applied to the sequence of real-valued data is represented as imaginary values of a DFT of odd size using the intermediate sequence y(n), the DST of type VI represented by
$${X}_{SVI} ( k ) = \frac{1}{2} Im ( Y ( 2 k + 1 ) ) , k = 0 , … , N - 1 ,$$
and
wherein the variable Y refers to a sequence of DFT output values computed by the DFT.

21. The apparatus of claim 20, wherein the transform module is further configure to apply a fast DFT algorithm to compute the sequence
$${X}_{SVI} ( k ) = \frac{1}{2} Im ( Y ( 2 k + 1 ) ) , k = 0 , … , N - 1 ,$$

22. The apparatus of claim 21, wherein the fast algorithm is a fast Fourier transform (FFT) algorithm.

23. The apparatus of claim 21, wherein the fast algorithm is a Winograd DFT module of length 9.

24. The apparatus of claim 19,
wherein the odd-type transform is a DCT of type VI,
wherein a DCT of type VI applied to the sequence of real-valued data is represented as real values of a DFT of odd size using the intermediate sequence y(n), the DCT of type VI represented by
$${X}_{CVI} ( k ) = \frac{1}{2} Re ( Y ( 2 k + 1 ) ) , k = 0 , … , N - 1. ,$$
and
wherein the variable Y refers to a sequence of DFT output values computed by the DFT.

25. The apparatus of claim 24, wherein the transform module is configured to apply a fast DFT algorithm to compute the sequence
$${X}_{CVI} ( k ) = \frac{1}{2} Re ( Y ( 2 k + 1 ) ) , k = 0 , … , N - 1.$$

26. The apparatus of claim 14, wherein the sequence of real-valued data has an odd number of values and is represented by x(n), wherein an individual value of the sequence of real-valued data is denoted as x(n) with variable n representing an index associated with the individual value of the sequence of real-valued data,
wherein the intermediate sequence is denoted by the variable y, wherein an individual value of the sequence is denoted as y(n) with variable n representing an index associated with the individual value of the intermediate sequence, and
wherein the mapping unit is further configured to map the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , ( N - 1 ) / 2 - 1 , \\ - x ( 2 k ) & if n = N - k , k = 0 , … , ( N + 1 ) / 2 - 1 , \\ x ( 2 k ) & if n = N + 1 + k , k = 0 , … , ( N + 1 ) / 2 - 1 , \\ x ( 2 k + 1 ) , & if n = 2 N - k , k = 0 , … , ( N - 1 ) / 2 - 1.\end{matrix}$$

27. An apparatus configured to compute an odd-type discrete sine transform (DST) or discrete cosine transform (DCT) in a video or image coding process comprising:
means for receiving a sequence of real-valued data on which to perform an odd-type transform;
means for mapping the sequence of real-valued data to an intermediate sequence; and
means for applying the intermediate sequence as an input to a discrete Fourier transform (DFT) to produce transformed data according to the odd-type transform, wherein the odd-type transform comprises one of a DST of type V, a DCT of type V, a DST of type VI, a DCT of type VI, a DST of type VII, a DCT of type VII, a DST of type VIII, and a DCT of type VIII.

28. The apparatus of claim 27, wherein the sequence of real-valued data is a sequence of image data.

29. The apparatus of claim 28, wherein the odd-type transform is a DST of type VI or a DST of type VII, and wherein the sequence of image data is a sequence of residual values from a prediction process in video coding.

30. The apparatus of claim 29, further comprising:
means for quantizing the transformed data to create quantized data; and
means for statistical lossless coding the quantized data to create encoded video.

31. The apparatus of claim 28, further comprising:
means for receiving encoded video data;
means for statistical lossless decoding the encoded video data to create quantized data; and
means for inverse quantizing the quantized data to create the sequence of real-valued data, wherein the odd-type transform is a DST of type VI or a DST of type VII, and wherein the transformed data is residual video data.

32. The apparatus of claim 27,
wherein the sequence of real-valued data has an even number of values and is represented by x(n), wherein an individual value of the sequence of real-valued data is denoted as x(n) with variable n representing an index associated with the individual value of the sequence of real-valued data;
wherein the intermediate sequence is denoted by the variable y, wherein an individual value of the sequence is denoted as y(n) with variable n representing an index associated with the individual value of the intermediate sequence, and
wherein the means for mapping the sequence of real-valued data comprises means for mapping the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , N / 2 - 1 , \\ - x ( 2 k ) & if n = N - k , k = 0 , … , N / 2 - 1 , \\ x ( 2 k ) & if n = N + 1 + k , k = 0 , … , N / 2 - 1 , \\ x ( 2 k + 1 ) , & if n = 2 N - k , k = 0 , … , N / 2 - 1.\end{matrix}$$

33. The apparatus of claim 32,
wherein the odd-type transform comprises the DST of type VI,
wherein the DST of type VI applied to the sequence of real-valued data is represented as imaginary values of a DFT of odd size using the intermediate sequence y(n), the DST of type VI represented by
$${X}_{SVI} ( k ) = \frac{1}{2} Im ( Y ( 2 k + 1 ) ) , k = 0 , … , N - 1 ,$$
and
wherein the variable Y refers to a sequence of DFT output values computed by the DFT.

34. The apparatus of claim 33, wherein the means for applying the intermediate sequence as an input to a discrete Fourier transform (DFT) to produce transformed data according to the DST of type VI comprises means for applying a fast DFT algorithm to compute the sequence
$${X}_{SVI} ( k ) = \frac{1}{2} Im ( Y ( 2 k + 1 ) ) , k = 0 , … , N - 1.$$

35. The apparatus of claim 34, wherein the fast algorithm is a fast Fourier transform (FFT) algorithm.

36. The apparatus of claim 34, wherein the fast algorithm is a Winograd DFT module of length 9.

37. The apparatus of claim 32,
wherein the odd-type transform is a DCT of type VI,
wherein a DCT of type VI applied to the sequence of real-valued data is represented as real values of a DFT of odd size using the intermediate sequence y(n), the DCT of type VI represented by
$${X}_{CVI} ( k ) = \frac{1}{2} Re ( Y ( 2 k + 1 ) ) , k = 0 , … , N - 1. ,$$
and
wherein the variable Y refers to a sequence of DFT output values computed by the DFT.

38. The apparatus of claim 37, wherein the means for applying the intermediate sequence as an input to a discrete Fourier transform (DFT) to produce transformed data according to the DCT of type VI comprises means for applying a fast DFT algorithm to compute the sequence
$${X}_{CVI} ( k ) = \frac{1}{2} Re ( Y ( 2 k + 1 ) ) , k = 0 , … , N - 1.$$

39. The apparatus of claim 27, wherein the sequence of real-valued data has an odd number of values and is represented by x(n), wherein an individual value of the sequence of real-valued data is denoted as x(n) with variable n representing an index associated with the individual value of the sequence of real-valued data,
wherein the intermediate sequence is denoted by the variable y, wherein an individual value of the sequence is denoted as y(n) with variable n representing an index associated with the individual value of the intermediate sequence, and
wherein the means for mapping the sequence of real-valued data comprises means for mapping the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , ( N - 1 ) / 2 - 1 , \\ - x ( 2 k ) & if n = N - k , k = 0 , … , ( N + 1 ) / 2 - 1 , \\ x ( 2 k ) & if n = N + 1 + k , k = 0 , … , ( N + 1 ) / 2 - 1 , \\ x ( 2 k + 1 ) , & if n = 2 N - k , k = 0 , … , ( N - 1 ) / 2 - 1.\end{matrix}$$

40. A computer program product comprising a computer-readable storage medium having stored thereon instructions that, when executed, cause a processor of a device configured to compute an odd-type discrete sine transform (DST) or discrete cosine transform (DCT) in a video or image coding process to:
receive a sequence of real-valued data on which to perform an odd-type transform;
map the sequence of real-valued data to an intermediate sequence; and
apply the intermediate sequence as an input to a discrete Fourier transform (DFT) to produce transformed data according to the odd-type transform, wherein the odd-type transform comprises one of a DST of type V, a DCT of type V, a DST of type VI, a DCT of type VI, a DST of type VII, a DCT of type VII, a DST of type VIII, and a DCT of type VIII.

41. The computer program product of claim 40, wherein the sequence of real-valued data is a sequence of image data.

42. The computer program product of claim 41, wherein the odd-type transform is a DST of type VI or a DST of type VII, and wherein the sequence of image data is a sequence of residual values from a prediction process in video coding.

43. The computer program product of claim 42, further comprising instructions to:
quantize the transformed data to create quantized data; and
statistical lossless code the quantized data to create encoded video.

44. The computer program product of claim 41, further comprising instructions to:
receive encoded video data;
statistical lossless decode the encoded video data to create quantized data; and
inverse quantize the quantized data to create the sequence of real-valued data, wherein the odd-type transform is a DST of type VI or a DST of type VII, and wherein the transformed data is residual video data.

45. The computer program product of claim 40,
wherein the sequence of real-valued data has an even number of values and is represented by x(n), wherein an individual value of the sequence of real-valued data is denoted as x(n) with variable n representing an index associated with the individual value of the sequence of real-valued data,
wherein the intermediate sequence is denoted by the variable y, wherein an individual value of the sequence is denoted as y(n) with variable n representing an index associated with the individual value of the intermediate sequence, and
wherein the instructions to map the sequence of real-valued data to an intermediate sequence comprise instructions to map the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , N / 2 - 1 , \\ - x ( 2 k ) & if n = N - k , k = 0 , … , N / 2 - 1 , \\ x ( 2 k ) & if n = N + 1 + k , k = 0 , … , N / 2 - 1 , \\ x ( 2 k + 1 ) , & if n = 2 N - k , k = 0 , … , N / 2 - 1.\end{matrix}$$

46. The computer program product of claim 45,
wherein the odd-type transform comprises the DST of type VI,
wherein the DST of type VI applied to the sequence of real-valued data is represented as imaginary values of a DFT of odd size using the intermediate sequence y(n), the DST of type VI represented by
$${X}_{SVI} ( k ) = \frac{1}{2} Im ( Y ( 2 k + 1 ) ) , k = 0 , … , N - 1 ,$$
and
wherein the variable Y refers to a sequence of DFT output values computed by the DFT.

47. The computer program product of claim 46, further comprising instructions to apply a fast DFT algorithm to compute the sequence
$${X}_{SVI} ( k ) = \frac{1}{2} Im ( Y ( 2 k + 1 ) ) , k = 0 , … , N - 1.$$

48. The computer program product of claim 47, wherein the fast algorithm is a fast Fourier transform (FFT) algorithm.

49. The computer program product of claim 47, wherein the fast algorithm is a Winograd DFT module of length 9.

50. The computer program product of claim 45,
wherein the odd-type transform is a DCT of type VI,
wherein a DCT of type VI applied to the sequence of real-valued data is represented as real values of a DFT of odd size using the intermediate sequence y(n), the DCT of type VI represented by
$${X}_{CVI} ( k ) = \frac{1}{2} Re ( Y ( 2 k + 1 ) ) , k = 0 , … , N - 1. ,$$
and
wherein the variable Y refers to a sequence of DFT output values computed by the DFT.

51. The computer program product of claim 49, further comprising instructions to apply a fast DFT algorithm to compute the sequence
$${X}_{CVI} ( k ) = \frac{1}{2} Re ( Y ( 2 k + 1 ) ) , k = 0 , … , N - 1.$$

52. The computer program product of claim 40, wherein the sequence of real-valued data has an odd number of values and is represented by x(n), wherein an individual value of the sequence of real-valued data is denoted as x(n) with variable n representing an index associated with the individual value of the sequence of real-valued data,
wherein the intermediate sequence is denoted by the variable y, wherein an individual value of the sequence is denoted as y(n) with variable n representing an index associated with the individual value of the intermediate sequence, and
wherein the instructions to map the sequence of real-valued data to an intermediate sequence comprise instructions to map the sequence of real-valued data x(n) to the intermediate sequence y(n) in accordance with the following equation:
$$y ( n ) = \{ \begin{matrix}0 , & if n = 0 , \\ - x ( 2 k + 1 ) , & if n = 1 + k , k = 0 , … , ( N - 1 ) / 2 - 1 , \\ - x ( 2 k ) & if n = N - k , k = 0 , … , ( N + 1 ) / 2 - 1 , \\ x ( 2 k ) & if n = N + 1 + k , k = 0 , … , ( N + 1 ) / 2 - 1 , \\ x ( 2 k + 1 ) , & if n = 2 N - k , k = 0 , … , ( N - 1 ) / 2 - 1.\end{matrix}$$
